(19) United States
(12) Patent Application Publication
(10) Pub. No.: US 2004/0220064 A1
(43) Pub. Date: Nov. 4, 2004

(54) Fragrance delivery vehicle

(76) Inventors: Thomas McGee, Nyack, NY (US); Richard P Sgaramella, Hoboken, NJ (US); Wirral Little Neston, Cheshire (GB)

Correspondence Address: Norris McLaughin & Marcus, 220 East 42nd Street, 30th Floor, New York, NY, 10017, US

(21) Appl. No.: 10/486,623

(22) PCT Filed: Aug. 12, 2002
(86) PCT No.: PCT/CH02/00438

Related U.S. Application Data
(63) Continuation of application No. 09/932,511, filed on Aug. 17, 2001, now abandoned.
Application No. 09/932,511 is a continuation-in-part of application No. PCT/US01/21334, filed on Jul. 5, 2001.
(60) Provisional application No. 60/216,571, filed on Jul. 7, 2000.

(51) Int. Cl. C11D 1/00

(52) U.S. Cl. 510/130

(57) ABSTRACT

The present invention provides a fragrance delivery vehicle including a water-insoluble oil, a conditioner containing a cationic active at a level above about 0.5% (wt), and at least about 0.1% (wt) of a fragrance composition comprising a first aroma chemical with a clogP of 3.0 or less and a second aroma chemical having a clogP of at least 4.0. Processes for conditioning and fragrancing a substrate, for enhancing the fragrance of a consumer product, and for designing a fragrance delivery vehicle are also provided.

The present invention relates to a fragrance delivery vehicle and processes for imparting optimal fragrance perception to a product and to a substrate, such as a dry fabric or hair. Processes for conditioning and fragrancing a substrate and fragrancing a product and for designing a fragrance delivery vehicle are also provided.

Liquid conditioning products for treating substrates, such as hair and fabric conditioners, containing cationic materials as key active ingredients are known. U.S. Pat. No. 5,652,206 (“Bacon”) discloses a fabric softener composition comprising cationic compounds and perfume. Bacon achieves improved perfume deposition on treated fabrics and minimizes the perfume lost during the rinse and dry cycles by means of designing perfumes having particular perfume ingredients in specific preparations. Designing perfumes is an art, and whereas Bacon sets down certain rules as to perfume design to achieve the desired properties, nevertheless it remains that the performance of the perfume will depend on its interaction with the other ingredients within the composition, e.g. cationic actives and other excipients. This means that achieving the desired results will still be a laborious and iterative process.

WO 97/44424 teaches a fabric conditioning composition comprising fabric softening compounds, e.g. nonionic and cationic softening compounds, fabric treatment agents, such as insect control agents and fabric anti-fading agents. Water-insoluble oils are used to achieve a better deposition of these fabric treatment agents. Perfumes are specifically excluded from the group of fabric treatment agents. Furthermore, whereas the inclusion of oil improves the deposition of fabric treatment agents the use thereof depresses the odor of the product. Accordingly, whereas water-insoluble oils have been employed in conjunction with fragrance agents, such as anti-fading agents, insect control agents, and hygiene agents, this reference has not apprehended that perfume deposition may be favorably influenced using such oils. As such, high levels of perfumes, some of which may be very expensive, are used to maintain a good odor perception from the product.

In the present invention, it has been found that enhanced deposition of fragrance from a composition containing cationic actives onto a treated substrate is achieved in a simple manner employing a water-insoluble oil. In particular, it has been found that a water-insoluble oil, when combined with a cationic active, provides excellent fragrance deposition to dry substrates, such as fabrics or hair.

However, whereas the use of such an oil is beneficial in the deposition of fragrances, nevertheless there may be concomitant suppression of the odor perception of the deposited fragrance. Preferably, therefore in order to maintain at least as good a perception of fragrance from the product compared to the perception of fragrance that is achieved from a simple cationic conditioning vehicle, one should formulate the fragrance specifically for the delivery vehicle, in particular the fragrance composition should be constructed to ensure that it contains a first aroma chemical with a clogP of 3.0 or less and a second aroma chemical with a clogP of at least 4.0.

Therefore, in a first aspect the present invention provides a fragrance delivery vehicle comprising a water-insoluble oil, a conditioner containing a cationic active at a level above 0.5% (wt), and at least 0.1% (wt) of a fragrance composition comprising a first aroma chemical with a clogP of 3.0 or less and a second aroma chemical having a clogP of at least 4.0.

The term “aroma chemical” as used herein means a chemical that is volatile and whose odor is detected by the nose. Aroma chemical means a single chemical or a mixture of chemicals fulfilling the definition of said aroma chemical.

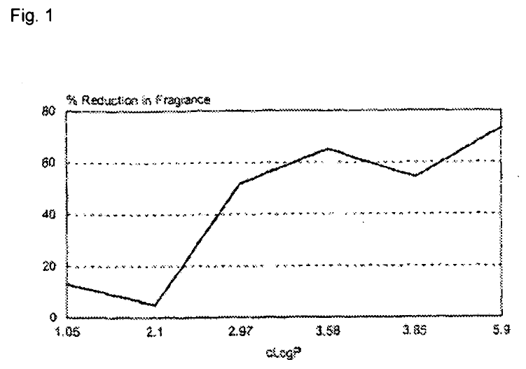

Given that it is known that use of a water-insoluble oil depresses fragrance release of the product and thus the perception of the fragrance, one would expect that to offset this loss of perception a large increase in all components of the fragrance composition is required. However, we surprisingly found that aroma chemicals having a clogP of 3 or less exhibited a significant lower % reduction in fragrance release compared with other aroma chemicals. Therefore, fragrance compositions containing such aroma chemicals exhibited improved odour impressions. This is shown graphically in FIG. 1.

One can easily measure the concentration of individual aroma chemicals by measuring the released fragrance for example by collecting and analysing the headspace of a product comprising said aroma chemical. The principles of the headspace analysis is described in the Journal of Agriculture and Food Chemistry, Vol. 19, No. 6 (1971), page 1049-1056.

The term “% Reduction in fragrance” as used herein above is the ratio between the fragrance release of a non oil-based fragrance delivery vehicle and the fragrance release of an oil-based fragrance delivery vehicle, which may be expressed by the following formula

$$\% Reduction in Fragrance = \frac{( HS non oil vehicle - HS oil based vehicle ) * 100}{HS non oil vehicle}$$

where HS is the headspace.

Accordingly, the invention provides a simple method of selecting appropriate aroma chemicals for oil-based fragrance delivery vehicles with a significantly lower % reduction in fragrance release by selecting aroma chemicals having a clogP of 3 or less. Furthermore, it is believed that the % reduction may by further decreased by selecting aroma chemicals that not only have a clogP of 3 or less but that have high vapor pressures and/or low sensory threshold values.

Thus, by selecting aroma chemicals with a clogP of 3 or less and high vapor pressures and/or low sensory threshold concentration, a fragrance composition may be designed that contains relatively small amounts of such aroma chemicals. This is beneficial to the perfumer because it reduces the cost of the fragrance composition, because smaller quantities of aroma chemicals are required, and it provides flexibility to the perfumer to be able to design mixtures of aroma chemicals that provide pleasing fragrances to product and/or substrates treated with the product.

As stated above, the first aroma chemical must have a clogP of 3 or less. Within this range, preferred are those aroma chemicals that exhibit a % reduction in fragrance of less than 40%, preferably less than 20%, for example less than 10%. Most preferred are aroma chemicals exhibiting a clogP of 2.5 or less.

Preferably, the first aroma chemical has a vapor pressure at 25° C. of greater than about 0.07 mm Hg, more preferably greater than about 0.7 mm Hg, such as for example, greater than about 1.0 mm Hg. Thus, the first aroma chemical may have a vapor pressure of between about 0.07 mm Hg and about 20.0 mm Hg.

In the present invention, the clogP and vapor pressure may be calculated using ACD Software from Advanced Chemicals Development ACD/Labs Software (Toronto, Ontario, Canada).

The sensory threshold concentration as used herein above refers to the concentration of an aroma chemical for which the probability of detection of the aroma stimulus is 0.5 (that is 50% chance, by a given individual, under the conditions of the test) The sensory threshold concentration can be measured by standard methods, for example described in ASTM E1432-91 and is measured either by olfactometry means or by using sniff-bottles allowing panellists to smell the presented headspace. It is also possible to smell the presented odour in a sequential process.

The first aroma chemical in the fragrance composition preferably has a sensory threshold concentration below 100 ng per liter, preferably, a sensory threshold concentration below 50 ng per liter, such as for example, a sensory threshold concentration below 30 ng per liter.

Preferably, the first aroma chemical may be selected from the group consisting of phenyl ethyl alcohol, phenyl ethyl formate, FRUCTONE (ethyl 2-methyl-1,3-dioxolane-2-acetate), methyl phenyl acetate, methyl amyl ketone, methyl hexyl ketone, ethyl phenyl acetate, CYCLAL (2,4-dimethyltetrahydeobenzaldehyde), cis-3-hexenyl formate, carvone, methyl phenyl acetate, prenyl acetate, isobutyl acetate, para cresyl acetate, cyclohexyl acetate, para tolyl aldehyde, cis-3-hexenol, aldehyde C7, aldehyde C8, ethyl caproate, ethyl-2-methyl-butyrate, ethyl butyrate, phenyl acetaldehyde, MANZANATE (ethyl 2-methylpentanoate), acetophenone, alcohol C6, amyl acetate, amyl alcohol, ANAPEAR (4,7-octadienoic acid, methyl ester), benzaldehyde, benzyl acetate, butyl acetate, butyl butyrate, cyclohexyl acetate, diethyl malonate, ethyl amyl ketone, ethyl benzoate, eucalyptol, alpha fenchone, fenchyl alcohol, hexyl acetate, iso menthone, iso pulegol, linalool oxide, melonal, nerol oxide, nonadienal, preonil, safranal and trans-hexenal.

However, preferably the following mixtures of aroma chemicals are not used together in the present invention. I. GARDENOL (alpha-Methylbenzyl acetate), LAURINE (hydroxycitronellal), FLOROL (2-Isobutyl-4-methyl-tetrahydropyran-4-ol), PROPYL DIANTILIS (3-ethoxy-4-hydroxy benzyl isopropyl ether), dihydroeugenol and DMBC acetate (Dimethyl benzyl carbinyl acetate); II phenyl ethyl alcohol and cis-3-hexanol and 1-citronellol.

Preferably, the second aroma chemical (i.e. the aroma chemical having a clogP of at least 4.0) has a vapor pressure at 25° C. of less than about 0.02 mm Hg, preferably less than about 0.01 mm Hg, such as for example less than about 0.008 mm Hg.

In the present invention, the fragrance composition contains at least about 0.5% (wt), preferably at least 1.0% (wt) of the first aroma chemical more preferably at least about 5% (wt), such as for example from 10-20% (wt) based on the weight of the fragrance composition. Likewise, the fragrance composition contains at least about 20% (wt) of the second aroma chemical, e.g. about 30%, 40%, 50% or 60% (wt) based on the weight of the fragrance composition. The balance of the fragrance composition may contain additional fragrances or filler materials, e.g. dipropylene glycol (DPG), ethanol, diethylphthalate (DEP) and triethylenglycol, conventionally used by a perfumer.

Additional fragrances according to the present invention are such aroma chemicals which do not have a clogP of 3.0 or less or a clogP of at least 4.0. They may be selected from the group of alcohols, aldehydes, ketones, esters, acetals, oximes, nitriles, ethers, and essential oil. Preferably additional fragrances are selected from peonil, linalool, citromellol, yara yara, cyclamen aldehyde, florhydral, ethyl linalool, beta ionone, methyl iso eugenol, phenoxanol, benzophnone, ocimene and allyl caproate. The fragrance composition according to the present invention is present in the fragrance delivery vehicle at a level that is at least about 0.1% (wt), such as for example at least about 0.2% (wt) or at least about 0.3% based on the weight of the fragrance delivery vehicle. Preferably, the fragrance composition is between about 0.1% to about 2.0% (wt) based on the weight of the fragrance delivery vehicle.

In the present invention, the cationic active may be selected from dialkyl cationic actives, monoalky cationic actives, and mixtures thereof. The dialky cationic active in the conditioner of the fragrance delivery vehicle may be, for example, dialkyldimethyl ammonium chloride, dialkyldimethyl ammonium methyl sulfate, di (hydrogenated tallow) dimethyl ammonium chloride, dihexadecyIdiethylammonium chloride, distearyldimethylammonium chloride, dibehenyldimethylammoinium chloride, di(coconut alkyl)dimethyl ammonium chloride, ditallowdimethyl ammonium chloride, ester quaternium compounds, dialkylyloxy dimethyl ammonium chloride, N,N-di(tallowyl-oxy-ethyl)-N N-dimethylammonium chloride, NN-(ditallowoxyl-oxy-ethyl)-N,N-dimethyl ammonium chloride, dialkyl imidazolium methyl sulfate, amido silicones, and mixtures thereof. The monoalkyl cationic active may be selected from cetyl trimethyl ammonium chloride, stearyl trimethyl ammonium chloride, and mixtures thereof.

The level of cationic active in a dilute fragrance delivery vehicle of the invention may be above 0.1%, for example above about 0.5% (wt), such as above about 1% (wt). In the present invention, the cationic active may be from about 0.5% (wt) to about 7.0% (wt), preferably about 0.7% (wt) to about 6.0% (wt), such as for example, about 1.0% (wt) to about 5.0% (wt). Levels of the cationic active in a concentrated delivery vehicle of the invention may be from about 7% (wt) to about 20% (wt), preferably about 10% (wt) to about 15% (wt).

The water-insoluble oils of the fragrance delivery vehicle may be selected from, for example, mineral oils, ester oils, sugar ester oils or oily sugar derivatives, natural oils, such as vegetable oils, and mixtures thereof. Preferably, the natural oil is a vegetable oil.

Preferably, the water-insoluble oils used in the present invention are hydrophobic. It is also preferred that the water-insoluble oil be an ester oil such as a sugar ester oil or an oil with substantially no surface activity. The level of water-insoluble oil in a dilute fragrance delivery vehicle of the invention is above about 0.1% (wt), such as for example, above about 0.5% (wt). Thus, the level of water-insoluble oil in the fragrance delivery vehicle may be for example, from about 0.1% (wt) to about 7.0% (wt), preferably about 0.3% (wt) to about 6.0% (wt), such as for example, about 0.5% (wt) to about 5.0% (wt). In a concentrated fragrance delivery vehicle of the invention, the level of water-insoluble oil is from about 1% (wt) to about 25% (wt), preferably about 3% (wt) to about 20% (wt). It is preferred that the water-insoluble oil used in the present invention be in liquid form.

In the present invention, the terms “sugar ester oil,” “sucrose polyester” (SPE), and “oily sugar derivative” are disclosed in WO 00/70004, which is incorporated by reference as if recited in full herein. Preferably, the ester oils are esters containing straight or branched, saturated or unsaturated carboxylic acids. The ester oil or oily sugar derivative is a liquid or soft solid derivative of a cyclic polyol, of a reduced saccharide or mixtures thereof, the resulting derivatives resulting from 35 to 100% of the hydroxyl groups in the polyol or in the saccharide being esterified or etherified. In the present invention, the derivative has two or more ester or ether groups independently attached to a C₈-C₂₂ alkyl or alkenyl chain.

The oily sugar derivatives of the invention are also referred to herein as “derivative-CP” and “derivative-RS” depending upon whether the derivative is a product derived from a cyclic polyol (CP) or from a reduced saccharide (RS) starting material respectively. Preferably, the derivative-CP and derivative-RS contain about 35% (wt) of tri- or higher esters, e.g. at least about 40%. Preferably about 35% to about 85% (wt), most preferably about 40% to about 80% (wt), even more preferably about 45% to about 75% (wt), such as about 45% to about 70% (wt) of the hydroxyl groups in the cyclic polyol or in the reduced saccharide are esterified or etherified to produce the derivative-CP and derivative-RS respectively.

For the derivative-CP and derivative-RS, the tetra, penta, etc. prefixes indicate the average degrees of esterification or etherification. The compounds exist as a mixture of materials ranging from the monoester to the fully esterified ester. It is the average degree of esterification as determined by weight that is referred to herein. The derivative-CP and derivative-RS used herein do not have substantial crystalline character at 20° C. Instead, they are preferably in a liquid or soft solid state, as hereinbelow defined, at 20° C.

The starting cyclic polyol or reduced saccharide material is esterified or etherified with C₈-C₂₂ alkyl or alkenyl chains to the appropriate extent of esterification or etherification so that the derivatives are in the requisite liquid or soft solid state. These chains may contain unsaturation, branching or mixed chain lengths.

Typically the derivative-CP or derivative-RS has 3 or more, preferably 4 or more, for example 3 to 8, such as 3 to 5, ester or ether groups or mixtures thereof. It is preferred two or more of the ester or ether groups of the derivative-CP and derivative-RS are, independently of one another, attached to a C₈ to C₂₂ alkyl or alkenyl chain. The alkyl or alkenyl groups may be branched or linear carbon chains.

In the present invention, the terms derivative-CP and derivative-RS encompass all ether or ester derivatives of all forms of saccharides, which fall into the above definition. Examples of preferred saccharides for the derivative-CP and derivative-RS to be derived from are monosaccharides and disaccharides.

Examples of monosaccharides within the scope of the present invention include xylose, arabinose, galactose, fructose, sorbose, and glucose. Glucose is especially preferred. An example of a reduced saccharide is sorbitan. Examples of disaccharides include maltose, lactose, cellobiose, and sucrose. Sucrose is especially preferred.

If the derivative-CP is based on a disaccharide, it is preferred that the disaccharide has three or more ester or ether groups attached to it. Examples of such sugars include sucrose tri-, tetra-, and penta-esters. Where the cyclic polyol is a reducing sugar, it is advantageous if each ring of the derivative-CP has one ether group, preferably at the C₁ position. Suitable examples of such compounds include methyl glucose derivatives. Examples of suitable derivative-CPs include esters of alkyl(poly)glucosides, in particular alkyl glucoside esters having a degree of polymerization from 1 to 2.

The HLB (hydrophilic lipophilic balance) of the derivative-CP and derivative-RS is typically between 1 and 3.

The derivative-CP and derivative-RS may have branched or linear, alkyl or alkenyl chains (with varying degrees of branching), mixed chain lengths, and/or unsaturation. Those having unsaturated and/or mixed alkyl chain lengths are preferred.

One or more of the alkyl or alkenyl chains (independently attached to the ester or ether groups) may contain at least one unsaturated bond.

For example, predominantly unsaturated fatty chains may be attached to the ester/ether groups. Such unsaturated fatty chains attached to the ester/ether groups may be derived from rape oil, cotton seed oil, soybean oil, oleic, tallow, palmitoleic, linoleic, erucic or other sources of unsaturated vegetable fatty acids.

The alkyl or alkenyl chains of the derivative-CP and derivative-RS are preferably predominantly unsaturated, for example sucrose tetratallowate, sucrose tetrarapeate, sucrose tetraoleate, sucrose tetraesters of soybean oil or cotton seed oil, cellobiose tetraoleate, sucrose trioleate, sucrose triapeate, sucrose pentaoleate, sucrose pentarapeate, sucrose hexaoleate, sucrose hexarapeate, sucrose triesters, pentaesters and hexaesters of soybean oil or cotton seed oil, glucose trioleate, glucose tetraoleate, xylose trioleate, or sucrose tetra-, tri-, penta- or hexa-esters with any mixture of predominantly unsaturated fatty acid chains.

Certain derivative-CPs and derivative-RSs within the scope of the present invention, however, may be based on alkyl or alkenyl chains derived from polyunsaturated fatty acid sources, e.g. sucrose tetralinoleate. It is preferred that most, if not all, of the polyunsaturation be removed by partial hydrogenation if such polyunsaturated fatty acid chains are used.

Oily sugar derivatives suitable for use in the present invention include sucrose pentalaurate, sucrose tetraoleate, sucrose pentaerucate, sucrose tetraerucate, sucrose, pentaoleate, and the like. Suitable materials include some of the Ryoto series available from Mitsubishi Kagaku Foods Corporation, such as for example, Ryoto ER290.

The liquid or soft solid derivative-CPs and derivative-RSs are characterized as materials having a solid:liquid ratio of between 50:50 and 0:100 at 20° C. as determined by T₂ relaxation time NMR, preferably between 43:57 and 0:100, most preferably between 40:60 and 0:100, such as, 20:80 and 0:100. The T₂ NMR relaxation time is commonly used for characterizing solid:liquid ratios in soft solid products such as fats and margarines. For the purpose of the present invention, any component of the NMR signal with a T₂ of less than 100 microseconds is considered to be a solid component and any component with T₂ greater than 100 microseconds is considered to be a liquid component.

The liquid or soft solid derivative-CP and derivative-RS can be prepared by a variety of methods well known to those skilled in the art. These methods include acylation of the cyclic polyol or of a reduced saccharide with an acid chloride; trans-esterification of the cyclic polyol or of a reduced saccharide material with short chain fatty acid esters in the presence of a basic catalyst (e.g. KOH); acylation of the cyclic polyol or of a reduced saccharide with an acid anhydride; and acylation of the cyclic polyol or of a reduced saccharide with a fatty acid. Typical preparations of these materials are disclosed in AU 14416/88 (Procter and Gamble).

Suitable oils include those in the Sirius range of mineral oils (e.g., Silkolene). Suitable ester oils include the saturated ester oils (e.g., Unichema) and the unsaturated sugar ester oils (e.g., Mitsubishi Kagaku). It is preferred that the ester oils of the invention be hydrophobic. It is further preferred that the ester oil be saturated (i.e., hardened) in nature, unless it is a sugar ester oil or a plant derivative, in which case, unsaturation is preferred.

Suitable ester oils are the fatty ester of a mono or polyhydric alcohol having from 1 to about 24 carbon atoms in the hydrocarbon chain and mono or polycarboxylic acids having from 1 to about 24 carbon atoms in the hydrocarbon chain, with the proviso that the total number of carbon atoms in the ester oil is equal to or greater than 16 and that at least one of the hydrocarbon radicals in the ester oil has 12 or more carbon atoms. Ester oils most suitable for use in the present invention are the PRIOLUBES from Unichema. In particular, PRIOLUBE 1407, PRIOLUBE 1447, PRIOLUBE 1415, PRIOLUBE 1446, PRIOLUBE 1427, PRIOLUBE 1445, PRIOLUBE 2045, PRIOLUBE 3988, PRIOLUBE 3987, PRIOLUBE 2091, ESTOL 1545, and ESTOL 1527 are advantageously employed in the present invention. Of these, ESTOL 1545, which is a 2-ethyl hexyl stearate, is particularly useful. Suitable mineral oils include the Esso Marcol technical grade range of oils, such as the Silkolene medicinal Sirius range (e.g., M40, M70, and M180). The molecular weight of the mineral oil is typically within the range 150 to 400.

It is preferred that the density of the mineral oil be from 0.80 to 0.90 g/cm², such as for example from 0.83 to 0.88 g/cm². The viscosity of the ester oil or mineral oil may be from 2 mPas to 400 mPas at a temperature of 25° C., preferably a viscosity from 2 mPas to 150 mPas, such as for example, a viscosity from 10 mPas to 100 mPas. The viscosity of the sugar ester oil should be below 50,000 mPas, preferably 5,000 mPas to 20,000 mPas, such as for example from 6,000 mPas to 20,000 mPas. All viscosities are measured at 25° C. It is further preferred that the refractive index of the oil be from 1.445 to 1.490, such as from 1.460 to 1.485.

The fragrance delivery vehicle may optionally contain, viscosity modifiers, antioxidants, deposition aids, UV absorbers, non ionics, zwiterionics, dye transfer ingredients, enzymes, antimicrobial agents, cationic agents, antistatic agents, dyes, fatty acids, emulsifiers, shape retention agents, anti-wrinkling agents, color care agents, bluing agents, optical brighteners, shine enhancers, preservatives, anti-corrosion agents, insect repellent agents, and mixtures thereof.

The fragrance delivery vehicle of the present invention also serves to improve the fragrance perception of any consumer product to which it is added. Thus, the fragrance delivery vehicle not only provides enhanced fragrance and conditioning to a substrate-to-be-treated (e.g., hair or fabric), but also provides or improves the fragrance of the underlying consumer product. Thus, in the present invention, a fragrance-improving quantity of the fragrance delivery vehicle may be incorporated (i.e., mixed into, or combined with) any suitable consumer product.

Accordingly, in another aspect the present invention refers to a process for enhancing the fragrance of a consumer product. This process includes incorporating a fragrance improving quantity of the fragrance delivery vehicle of the present invention into a consumer product.

In the present invention, a “fragrance-improving quantity of the fragrance delivery vehicle” corresponds to the amount of the fragrance delivery vehicle required to condition and impart a fragrance to a substrate and to impart a fragrance to the consumer product. Thus, a fragrance-improving quantity of the fragrance delivery vehicle as used herein means from about 0.5 to about 25% (wt), preferably from about 1% to about 20% (wt), such as for example from about 2% to about 15% (wt) based on the weight of the consumer product.

As used herein, a consumer product includes any commercially available product to which the present fragrance delivery vehicles may be added, without significantly altering the underlying function of the consumer product. Thus, a consumer product includes for example, laundry detergents, fabric and hair conditioners, shampoos, hair creams, fabric softeners, fabric dewrinklers, cleansers, and the like.

Another aspect of the present invention is a process for conditioning and fragrancing a substrate and fragrancing a product comprising combining a fragrance delivery vehicle according to the present invention with a product for conditioning and fragrancing a substrate, the fragrance delivery vehicle comprising a water-insoluble oil, a conditioner containing a cationic active at a level above about 0.5% (wt), and at least about 0.1% (wt) of a fragrance composition comprising a first aroma chemical with a clogP of 3.0 or less and a second aroma chemical having a clogP of at least 4.0; and contacting the product containing the fragrance delivery vehicle with a substrate in an aqueous medium.

As used herein, the phrase “fabric conditioner” means a product that imparts softness, drape, and other similar benefits, such as antistatic properties or color care properties to fabrics. As used herein the phrase “hair conditioner” means a product that imparts softness, easier combing, and shine to hair. In the present invention, the term “conditioner” is used throughout to refer to fabric conditioners, hair conditions, or both, as the context may dictate.

In the present invention, the product containing the fragrance delivery vehicle is contacted with the substrate using any conventional method, such as for example by adding the product to the rinse cycle of a conventional washing machine in the case of a fabric. The product is typically contacted with the substrate in an aqueous medium. In the present invention, the aqueous medium is water or a solution containing a substantial amount of water (e.g., greater than about 70%, preferably greater than about 90-95% water) that is suitable for fabric or hair washing.

Preferably, the substrate is dried after it is contacted with the fragrance delivery vehicle-containing product. In the present invention, the substrate may be a fabric or hair. Preferably, the product is a consumer product as set forth previously.

As used herein, the term “substrate” means hair or a fabric (natural, synthetic, or natural/synthetic blends) that is suitable for conventional washing and drying.

A further aspect of the present invention is a process for designing a fragrance delivery vehicle that provides fragrance to a consumer product and that provides fragrance and conditioning to a dry substrate when treated with the fragrance delivery vehicle. This process includes selecting a first aroma chemical having a clogP of 3 or less, which first aroma chemical is preferably further selected from the group consisting of aroma chemicals having a vapor pressure at 25° C. of greater than 0.07 mm Hg and aroma chemicals having a sensory threshold concentration of less than 100 ng per liter. The first aroma chemical is then combined with a second aroma chemical having a clogP of at least 4.0 using any conventional method, such as mixing, to form a fragrance composition, which may further be combined with additional fragrances, i.e. aroma chemicals which do not have a clogP of 3.0 or less or a clogP of at least 4.0, or fillers.

As noted above, the fragrance composition preferably contains mixtures of one or more of the first and second aroma chemicals. At least about 0.1% (wt) of the fragrance composition is then incorporated with a water-insoluble oil and a conditioner containing a cationic active at a level above about 0.5% (wt) to form the fragrance delivery vehicle.

The following examples are provided to further illustrate the present invention.

### EXAMPLE 1

The following delivery vehicles were prepared by mixing the ingredients at 50° C.:

delivery vehicle

| Ingredients | A | B |
|---|---|---|
| HEQ* | 12.00% | 12.00% |
| SPE** | — | 4.00% |
| Fragrance composition A | 0.95% | 0.95% |
| Water, preservative, dye | to 100.00% | to 100.0% |

*HEQ is an ester quaternium compound, dialkylyloxy dimethyl ammonium chloride, where the alky is hardened tallow;
**SPE is a Sucrose Poly Ester Ryoto ER290;

Fragrance Composition A:

| | | | Vapor Pressure |
|---|---|---|---|
| | % (w/w) | cLogP | (mm HG@25° C.) |
| Heliotropine | 2.00 | 1.1 | 0.01 |
| Coumarin | 1.75 | 1.4 | 0.002 |
| Anisic aldehyde | 1.30 | 1.7 | 0.039 |
| Hedione | 4.60 | 2.5 | 0.001 |
| Diethyl phthalate | 9.75 | 2.7 | 0.002 |
| Methyl naphthyl ketone | 0.70 | 2.9 | 0.001 |
| Dihydro myrcenol | 1.50 | 3.0 | 0.166 |
| Dimethyl benzyl carbinyl | 1.20 | 3.0 | 0.014 |
| acetate | | | |
| Peonil | 10.60 | 3.2 | 0.001 |
| Linalool | 1.40 | 3.3 | 0.091 |
| Citronellol | 1.90 | 3.4 | 0.015 |
| Yara yara | 2.30 | 3.4 | 0.01 |
| Cyclamen aldehyde | 0.90 | 3.7 | 0.009 |
| Florhydral | 1.20 | 3.7 | 0.02 |
| Ethyl linalool | 3.80 | 3.8 | 0.005 |
| Beta ionone | 2.40 | 3.9 | 0.017 |
| Alpha damascone | 0.10 | 4.0 | 0.008 |
| Benzyl salicylate | 1.60 | 4.0 | 0.001 |
| Linayl acetate | 0.30 | 4.1 | 0.116 |
| Lilial | 10.50 | 4.1 | 0.004 |
| Gamma methyl ionone | 4.20 | 4.3 | 0.01 |
| Gamma terpinene | 0.10 | 4.4 | 1.05 |
| Ebanol | 1.50 | 4.4 | 0.002 |
| Limonene | 3.70 | 4.6 | 1.51 |
| Tetra hydro linalool | 3.00 | 4.8 | 0.003 |
| Hexyl salicylate | 6.90 | 4.9 | 0.001 |
| Hexyl Cinnamic Aldehyde | 11.40 | 4.9 | 0.001 |
| Aldehyde C12 MNA | 0.40 | 5.0 | 1.428 |
| Radjanol | 1.40 | 5.0 | 0.001 |
| Iso-E Super | 4.30 | 5.3 | 0.001 |
| Thibetolide | 3.30 | 5.4 | 0.001 |
| total | 100.00 | | |

Upon smelling each fragrance delivery vehicle, it was noted that the fragrance of the delivery vehicle B was significantly less intense compared to the delivery vehicle A.

Each delivery vehicle containing the fragrance composition was equilibrated for 24 hours at room temperature. Terry Toweling test pieces were desized by washing three times in a liquid detergent (Purex HDL liquid) at 50° C. in a conventional consumer washing machine. The toweling was washed with water four times. The toweling test pieces were then tumble-dried in a conventional consumer dryer set at normal cycle. The test pieces were then rinsed in the respective fragrance delivery vehicle in a Terg-O-Tometer using tap water at 25° C. with a cloth to liquor ratio of 1:25, a product concentration of 0.6% and an agitation of 65 rpm for 5 min. The test pieces were spun dry to a constant weight. The test pieces were then line dried.

Each test piece was placed in a glass headspace collection vessel and 2 liters of headspace was collected on a Tenax trap. The fragrance components were thermally desorbed into an Agilent 6890 capillary GC fitted with a high sensitivity Mass Selective Detector. The amount of fragrance determined in the headspace is shown below:

| | Quantity of fragrance in headspace |
|---|---|
| Delivery vehicle | [ng/liter] |
| A | 749.5 |
| B | 3099.9 |

As the data show, the cationic oil-based delivery vehicle, i.e. delivery vehicle B, is clearly delivering much more fragrance to fabric than the delivery vehicle comprising no oil, i.e. delivery vehicle A.

### EXAMPLE 2

The following fragrance composition were made:

| | | |
|---|---|---|
| | | Vapor Pressure |
| % (w/w) | cLogP | (mm HG@25° C.) |

1. Fragrance composition B

| | | | |
|---|---|---|---|
| Coumarin | 10 | 1.4 | 0.002 |
| Methyl jasmonate | 10 | 2.1 | 0.001 |
| Methyl cinnamate | 10 | 2.2 | 0.008 |
| Eugenyl acetate | 10 | 2.4 | 0.008 |
| Hedione | 10 | 2.5 | 0.001 |
| Dihydro eugenol | 10 | 2.7 | 0.006 |
| Methyl iso eugenol | 10 | 3.1 | 0.002 |
| Phenoxanol | 10 | 3.2 | 0.001 |
| Benzophenone | 10 | 3.2 | 0.001 |

| | | |
|---|---|---|
| Dipropylene glycol (DPG) | 10 | solvent |
| total | 100 | |

2. Fragrance composition C

| | | | |
|---|---|---|---|
| Lilial | 25 | 4.1 | 0.002 |
| Hexyl Salicylate | 25 | 4.89 | 0.0008 |
| Galaxolide (50% in DEP) | 25 | 6.0 | 0.0002 |
| Fixolide | 25 | 6.4 | 0.0001 |

A fragrance delivery vehicle comprising 1.0% of the perfume F to F50, mixed in the ratio set forth below, and 6.5% HEQ and 6.5% SPE were prepared.

Fragrance composition

| Perfume | B | C |
|---|---|---|
| F | 100% | — |
| F10 | 90% | 10% |
| F20 | 80% | 20% |
| F30 | 70% | 30% |
| F40 | 60% | 40% |
| F50 | 50% | 50% |

Desized Terry Toweling test cloths were pre-washed in 2.05 g of a liquid detergent (Purex Free detergent liquid) in tap water at 100° F. (37.8° C.) in a Terg-O-Tometer. The cloth to liquor ratio was 1:20. The towels were rinsed once in 2 liters of tap water. To the final rinse, 2.05 g of the respective fragrance delivery vehicle was added and agitated for 5 minutes. The toweling pieces were spun dry.

The test pieces were then line dried and an expert panel of 5 people was asked to assess them as to whether they perceived that the fabric piece was fragranced. The results obtained are presented below:

| Product | Detected fragrance | Did not detect fragrance |
|---|---|---|
| F | 1 | 4 |
| F10 | 1 | 4 |
| F20 | 3 | 2 |
| F30 | 4 | 1 |
| F40 | 5 | 0 |
| F50 | 5 | 0 |

Thus, in the fragrance delivery vehicle containing a water-insoluble oil the fragrance composition must have at least 20% of aroma chemicals with a clogP of at least 4.0 in order to fragrance dry fabric.

### EXAMPLE 3

The following fragrance delivery vehicle samples were prepared:

| | | | perfume composition | | | |
|---|---|---|---|---|---|---|
| Sam- | | | F50* + add. fragrance + DPG | | | |
| ple | HEQ | SPE | component | | | Water |
| 3A | 13%+ | 0%+ | 0.9% | +0% | +0.1% | to 100% |
| 3B | 6.5%+ | 6.5%+ | 0.9% | +0% | +0.1% | to 100% |
| 3C | 6.5%+ | 6.5%+ | 0.9% | +0.04%¹⁾ | +0.06% | to 100% |
| 3D | 6.5%+ | 6.5%+ | 0.9% | +0.04%²⁾ | +0.06% | to 100% |
| 3E | 6.5%+ | 6.5%+ | 0.9% | +0.04%³⁾ | +0.06% | to 100% |
| 3F | 6.5%+ | 6.5%+ | 0.9% | +0.04%⁴⁾ | +0.06% | to 100% |
| 3G | 6.5%+ | 6.5%+ | 0.9% | +0.04%⁵⁾ | +0.06% | to 100% |

*F50 is the perfume composition according to example 2.

where the additional fragrance component in the respective perfume compositions was:

| | | Vapor Pressure |
|---|---|---|
| | ClogP | (mm Hg at 25° C.) |
| 1) Ocimene | 3.7 | 1.559 |
| 2) Allyl caproate | 3.2 | 0.680 |
| 3) Cyclal C | 2.67 | 0.578 |
| 4) Cis 3 Hexenyl acetate | 2.5 | 1.182 |
| 5) Cyclohexyl acetate | 2.24 | 1.21 |

After combining the ingredients, the samples were allowed to equilibrate for 24 hours at room temperature. Samples 3B to 3G were compared in paired comparisons against 3A (control) for fragrance intensity. 5 expert panelists were used. The results are shown below:

| Sample Comparison | Number Selecting |
|---|---|
| 3A [symbol] 3B | 5 [symbol] 0 |
| 3A [symbol] 3C | 5 [symbol] 0 |
| 3A [symbol] 3D | 3 [symbol] 2 |
| 3A [symbol] 3E | 1 [symbol] 4 |
| 3A [symbol] 3F | 0 [symbol] 5 |
| 3A [symbol] 3G | 0 [symbol] 5 |

As the data show, the oil-based fragrance delivery vehicles of the present invention have a fragrance intensity that is at least equal to the non-oil containing delivery vehicle when the fragrance composition contains an aroma chemical with a clogP below 3.0 and a high vapor pressure of about 0.5 mm Hg at 25° C. or greater (e.g., Samples 3E, 3F, and 3G).

### EXAMPLE 4

The following fragrance delivery vehicle samples were prepared:

| | | | perfume composition | | | |
|---|---|---|---|---|---|---|
| Sam- | | | F50* + add. fragrance + DPG | | | |
| ple | HEQ | SPE | component | | | Water |
| 4A | 13%+ | 0%+ | 0.9% | +0% | +0.1% | to 100% |
| 4B | 6.5%+ | 6.5%+ | 0.9% | +0% | +0.1% | to 100% |
| 4C | 6.5%+ | 6.5%+ | 0.9% | +0.04%⁶⁾ | +0.06% | to 100% |
| 4D | 6.5%+ | 6.5%+ | 0.9% | +0.04%⁷⁾ | +0.06% | to 100% |
| 4E | 6.5%+ | 6.5%+ | 0.9% | +0.04%⁸⁾ | +0.06% | to 100% |
| 4F | 6.5%+ | 6.5%+ | 0.9% | +0.04%⁹⁾ | +0.06% | to 100% |
| 4G | 6.5%+ | 6.5%+ | 0.9% | +0.04%¹⁰⁾ | +0.06% | to 100% |
| 4H | 6.5%+ | 6.5%+ | 0.9% | +0.04%¹¹⁾ | +0.06% | to 100% |
| 4I | 6.5%+ | 6.5%+ | 0.9% | +0.04%¹²⁾ | +0.06% | to 100% |
| 4J | 6.5%+ | 6.5%+ | 0.9% | +0.04%¹³⁾ | +0.06% | to 100% |

*F50 is the perfume composition according to example 2.

where the additional fragrance component in the respective perfume compositions was:

| | | Vapor Pressure |
|---|---|---|
| | ClogP | (mm Hg at 25°C.) |
| 6) Phenyl propyl alcohol | 1.9 | 0.027 |
| 7) Phenyl ethyl alcohol | 1.4 | 0.074 |
| 8) Benzyl acetate | 1.9 | 0.164 |
| 9) Benzyl formate | 1.5 | 0.270 |
| 10) Anapear | 1.6 | 0.777 |
| 11) Alcohol C6 | 1.9 | 0.947 |
| 12) cis-3-hexenol | 1.6 | 1.040 |
| 13) trans-2-hexenal | 1.6 | 11.200 |

After mixing the ingredients, the fragrance delivery samples were allowed to equilibrate for 24 hours at room temperature. Samples 4B to 4J were compared in paired comparisons against 4A (control) for fragrance intensity. 5 expert panelists were used the results are shown below:

| Sample Comparison | Number Selecting |
|---|---|
| 4A [symbol] 4B | 5 [symbol] 0 |
| 4A [symbol] 4C | 4 [symbol] 1 |
| 4A [symbol] 4D | 3 [symbol] 2 |
| 4A [symbol] 4E | 1 [symbol] 4 |
| 4A [symbol] 4F | 1 [symbol] 4 |
| 4A [symbol] 4G | 1 [symbol] 4 |
| 4A [symbol] 4H | 1 [symbol] 4 |
| 4A [symbol] 4I | 0 [symbol] 5 |
| 4A [symbol] 4J | 0 [symbol] 5 |

As the data demonstrate, the intensity of the fragrance is maintained in the fragrance delivery vehicle with aroma chemicals with a vapor pressure above 0.07 mm Hg vapor pressure at 25° C., preferably greater than 0.1 mm Hg vapor pressure at 25° C.

### EXAMPLE 5

Low Odor Intensity Aroma Chemical:

Phenyl ethyl alcohol and Fructone are low odor intensity materials:

| | | Vapor Pressure |
|---|---|---|
| Ingredient | clogP | (mm Hg at 25° C.) |
| Phenyl ethyl alcohol | 1.4 | 0.074 |
| Fructone | 0.6 | 0.086 |

The following fragrance delivery vehicle samples were prepared:

| | |
|---|---|
| 6A | 13% HEQ + 0.9% F50 + 0.1% DPG (control) |
| 6B | 6.5% HEQ + 6.5% SPE + 0.9% F50 + 0.1% DPG |
| 6C | 6.5% HEQ + 6.5% SPE + 0.9% F50 + 0.02% Phenyl ethyl alcohol + |
| | 0.08% DPG |
| 6D | 6.5% HEQ + 6.5% SPE + 0.9% F50 + 0.04% Phenyl ethyl alcohol + |
| | 0.06% DPG |
| 6E | 6.5% HEQ + 6.5% SPE + 0.9% F50 + 0.06% Phenyl ethyl alcohol + |
| | 0.04% DPG |
| 6F | 6.5% HEQ + 6.5% SPE + 0.9% F50 + 0.08% Phenyl ethyl alcohol + |
| | 0.02% DPG |
| 6G | 6.5% HEQ + 6.5% SPE + 0.9% F50 + 0.1% Phenyl ethyl alcohol |
| 6H | 6.5% HEQ + 6.5% SPE + 0.9% F50 + 0.02% Fructone + |
| | 0.08% DPG |
| 6I | 6.5% HEQ + 6.5% SPE + 0.9% F50 + 0.04% Fructone + |
| | 0.06% DPG |
| 6J | 6.5% HEQ + 6.5% SPE + 0.9% F50 + 0.06% Fructone + |
| | 0.04% DPG |
| 6K | 6.5% HEQ + 6.5% SPE + 0.9% F50 + 0.08% Fructone + |
| | 0.02% DPG |
| 6L | 6.5% HEQ + 6.5% SPE + 0.9% F50 + 0.1% Fructone |

After mixing, the fragrance delivery vehicle samples were allowed to equilibrate for 24 hours at room temperature.

Samples 6B to 6G were compared in paired comparisons against 6A (control) for fragrance intensity. 5 expert panelists were used. The results are shown below:

| Sample Comparison | Number Selecting |
|---|---|
| 6A [symbol] 6B | 5 [symbol] 0 |
| 6A [symbol] 6C | 4 [symbol] 1 |
| 6A [symbol] 6D | 3 [symbol] 2 |
| 6A [symbol] 6E | 1 [symbol] 4 |
| 6A [symbol] 6F | 1 [symbol] 4 |
| 6A [symbol] 6G | 0 [symbol] 5 |

Samples 6H to 6L were compared in paired comparisons against 6A (control) for fragrance intensity. 5 expert panelists were used. The results are shown below:

| Sample Comparison | Number Selecting |
|---|---|
| 6A [symbol] 6H | 3 [symbol] 2 |
| 6A [symbol] 6I | 2 [symbol] 3 |
| 6A [symbol] 6J | 1 [symbol] 4 |
| 6A [symbol] 6K | 1 [symbol] 4 |
| 6A [symbol] 6L | 0 [symbol] 5 |

As the data indicate, low odor intensity materials when used alone with the F50 fragrance must account for at least 2% of the fragrance to maintain the intensity that the fragrance would have in a non-oil based cationic system.

### EXAMPLE 6

Moderate Odor Intensity Aroma Chemical:

The following aroma chemicals a have a moderate odor intensity:

| | | Vapor Pressure |
|---|---|---|
| Ingredient | clogP | (mm Hg at 25° C.) |
| Methyl amyl ketone | 2.0 | 4.732 |
| Prenyl acetate | 2.1 | 3.987 |
| Cyclohexyl acetate | 2.2 | 0.978 |
| Aldehyde C7 | 2.5 | 3.854 |
| Aldehyde C8 | 3.0 | 1.409 |

The following fragrance delivery vehicle samples were prepared:

| | |
|---|---|
| 7A | 13% HEQ + 0.9% F50 + 0.1% DPG (control) |
| 7B | 6.5% HEQ + 6.5% SPE + 0.9% F50 + 0.004% Methyl amyl ketone + 0.096% DPG |
| 7C | 6.5% HEQ + 6.5% SPE + 0.9% F50 + 0.006% Methyl amyl ketone + 0.094% DPG |
| 7D | 6.5% HEQ + 6.5% SPE + 0.9% F50 + 0.008% Methyl amyl ketone + 0.092% DPG |
| 7E | 6.5% HEQ + 6.5% SPE + 0.9% F50 + 0.01% Methyl amyl ketone + 0.09% DPG |
| 7F | 6.5% HEQ + 6.5% SPE + 0.9% F50 + 0.02% Methyl amyl ketone + 0.08% DPG |
| 7G | 6.5% HEQ + 6.5% SPE + 0.9% F50 + 0.002% Prenyl acetate + 0.098% DPG |
| 7H | 6.5% HEQ + 6.5% SPE + 0.9% F50 + 0.004% Prenyl acetate + 0.096% DPG |
| 7I | 6.5% HEQ + 6.5% SPE + 0.9% F50 + 0.006% Prenyl acetate + 0.094% DPG |
| 7J | 6.5% HEQ + 6.5% SPE + 0.9% F50 + 0.008% Prenyl acetate + 0.092% DPG |
| 7K | 6.5% HEQ + 6.5% SPE + 0.9% F50 + 0.01% Prenyl acetate |
| 7L: | 6.5% HEQ + 6.5% SPE + 0.9% F50 + 0.0003% Cyclohexyl acetate + 0.0997% DPG |
| 7M: | 6.5% HEQ + 6.5% SPE + 0.9% F50 + 0.0006% Cyclohexyl acetate + 0.0994% DPG |
| 7N: | 6.5% HEQ + 6.5% SPE + 0.9% F50 + 0.001% Cyclohexyl acetate + 0.099% DPG |
| 7O | 6.5% HEQ + 6.5% SPE + 0.9% F50 + 0.0001% Aldehyde C7 + 0.0999% DPG |
| 7P | 6.5% HEQ + 6.5% SPE + 0.9% F50 + 0.0003% Aldehyde C7 + 0.0997% DPG |
| 7Q | 6.5% HEQ + 6.5% SPE + 0.9% F50 + 0.0001% Aldehyde C8 + 0.0999% DPG |
| 7R | 6.5% HEQ + 6.5% SPE + 0.9% F50 + 0.0003% Aldehyde C8 + 0.0997% DPG |

After mixing, the fragrance delivery vehicle samples were allowed to equilibrate for 24 hours at room temperature.

Samples 7B to 7F were compared in paired comparisons against 7A (control) for fragrance intensity. 5 expert panelists were used. The results are shown below:

| Sample Comparison | Number Selecting |
|---|---|
| 7A [symbol] 7B | 4 [symbol] 1 |
| 7A [symbol] 7C | 4 [symbol] 1 |
| 7A [symbol] 7D | 1 [symbol] 4 |
| 7A [symbol] 7E | 0 [symbol] 5 |
| 7A [symbol] 7F | 0 [symbol] 5 |

Samples 7G to 7K were compared in paired comparisons against 7A (control) for fragrance intensity. 5 expert panelists were used. The results are shown below:

| Sample Comparison | Number Selecting |
|---|---|
| 7A [symbol] 7G | 2 [symbol] 3 |
| 7A [symbol] 7H | 1 [symbol] 4 |
| 7A [symbol] 7I | 0 [symbol] 5 |
| 7A [symbol] 7J | 0 [symbol] 5 |
| 7A [symbol] 7K | 0 [symbol] 5 |

Samples 7L to 7N were compared in paired comparisons against 7A (control) for fragrance intensity. 5 expert panelists were used. The results are shown below:

| Sample Comparison | Number Selecting |
|---|---|
| 7A [symbol] 7L | 2 [symbol] 3 |
| 7A [symbol] 7M | 0 [symbol] 5 |
| 7A [symbol] 7N | 0 [symbol] 5 |

Samples 7O to 7P were compared in paired comparisons against 7A (control) for fragrance intensity. 5 expert panelists were used. The results are shown below:

| Sample Comparison | Number Selecting |
|---|---|
| 7A [symbol] 7O | 1 [symbol] 4 |
| 7A [symbol] 7P | 0 [symbol] 5 |

Samples 7Q to 7R were compared in paired comparisons against 7A (control) for fragrance intensity. 5 expert panelists were used. The results are shown below:

| Sample Comparison | Number Selecting |
|---|---|
| 7A [symbol] 7Q | 1 [symbol] 4 |
| 7A [symbol] 7R | 0 [symbol] 5 |

As the data indicate, selecting moderate odor intensity aroma chemicals, having a clogP of 3.0 or less and a vapor pressure in excess of 0.07 mm Hg at 25° C., when incorporated into a fragrance above 0.05% is sufficient to maintain good fragrance intensity in a cationic-oil system.

### EXAMPLE 7

High Odor Intensity Aroma Chemical

The following aroma chemicals have high odor intensity:

| Ingredient | clogP | Vapor Pressure (mm Hg @ 25° C.) |
|---|---|---|
| Ethyl-2-methyl-butyrate | 1.6 | 7.853 |
| Manzanate | 2.7 | 2.908 |

The following fragrance delivery vehicle samples were prepared:

| | |
|---|---|
| 8A | 6.5% HEQ + 6.5% SPE + 0.9% F50 + 0.0001% Ethyl-2-methyl- |
| | butyrate + 0.0999% DPG |
| 8B | 6.5% HEQ + 6.5% SPE + 0.9% F50 + 0.0003% Ethyl-2-methyl- |
| | butyrate + 0.0997% DPG |
| 8C | 6.5% HEQ + 6.5% SPE + 0.9% F50 + 0.0001% Manzanate + |
| | 0.0999% DPG |
| 8D | 6.5% HEQ + 6.5% SPE + 0.9% F50 + 0.0003% Manzanate + |
| | 0.0997% DPG |

After mixing, the fragrance delivery vehicle samples were allowed to equilibrate for 24 hours at room temperature.

Samples 8A to 8B were compared in paired comparisons against 7A (control) for fragrance intensity. 5 expert panelists were used. The results are shown below:

| Sample Comparison | Number Selecting |
|---|---|
| 7A [symbol] 8A | 1 [symbol] 4 |
| 7A [symbol] 8B | 0 [symbol] 5 |

Samples 8C to 8D were compared in paired comparisons against the control (7A) for fragrance intensity. 5 expert panelists were used. The results are shown below:

| Sample Comparison | Number Selecting |
|---|---|
| 7A [symbol] 8C | 1 [symbol] 4 |
| 7A [symbol] 8D | 0 [symbol] 5 |

As the data indicate, high intensity aroma chemicals having a clogP of 3.0 or less and a vapor pressure in excess of 0.07 mm Hg at 25 C, when incorporated into a fragrance composition above 0.01% is sufficient to maintain good fragrance intensity in a cationic oil-based system.

### EXAMPLE 8

The following products were prepared:

| Ingredient | Dilute | Concentrated |
|---|---|---|
| HEQ | 5.0 | 12 |
| SPE | 1.7 | 4.0 |
| Coconut 3 EO non-ionic | — | 0.7 |
| Cetyl hydroxy ethyl cellulose | 0.03 | — |
| Proxel (preservative) | 0.16 | 0.15 |
| Dye | 0.0015 | 0.0048 |
| Pearleacer(mica) | 0.1 | 0.0048 |
| Perfume* | 0.32 | 0.95 |
| Water | To 100 | To 100 |

*either the fragrance composition A (see example 2) or the fragrance composition D (see formulation below) were used.

Fragrance Composition D:

| | | | Vapor Pressure |
|---|---|---|---|
| | % (w/w) | cLogP | (mm HG@25° C.) |
| Coumarin | 1.75 | 1.4 | 0.002 |
| Ethyl methyl butyrate | 0.05 | 1.6 | 7.853 |
| Anapear | 0.85 | 1.6 | 0.777 |
| Acetophenone | 0.50 | 1.7 | 0.851 |
| Anisic aldehyde | 1.30 | 1.7 | 0.039 |
| Hedione | 4.60 | 2.5 | 0.001 |
| Cyclal C | 0.60 | 2.7 | 0.578 |
| Diethyl phthalate | 9.75 | 2.7 | 0.002 |
| Methyl naphthyl ketone | 0.70 | 2.9 | 0.001 |
| Dihydro myrcenol | 1.50 | 3.0 | 0.166 |
| Dimethyl benzyl carbinyl | 1.20 | 3.0 | 0.014 |
| acetate | | | |
| Peonil | 10.6 | 3.2 | 0.001 |
| Linalool | 1.40 | 3.3 | 0.091 |
| Citronellol | 1.90 | 3.4 | 0.015 |
| Yara yara | 2.30 | 3.4 | 0.01 |
| Cyclamen aldehyde | 0.90 | 3.7 | 0.009 |
| Florhydral | 1.20 | 3.7 | 0.02 |
| Ethyl linalool | 3.80 | 3.8 | 0.005 |
| Beta ionone | 2.40 | 3.9 | 0.017 |
| Alpha damascone | 0.10 | 4.0 | 0.008 |
| Benzyl salicylate | 1.60 | 4.0 | 0.001 |
| Linayl acetate | 0.30 | 4.1 | 0.116 |
| Lilial | 10.50 | 4.4 | 0.004 |
| Gamma methyl ionone | 4.20 | 4.3 | 0.01 |
| Gamma terpinene | 0.10 | 4.4 | 1.05 |
| Ebanol | 1.50 | 4.4 | 0.002 |
| Limonene | 3.70 | 4.6 | 1.51 |
| Tetra hydro linalool | 3.00 | 4.8 | 0.003 |
| Hexyl salicylate | 6.90 | 4.9 | 0.001 |
| Hexyl Cinnamic Aldehyde | 11.40 | 4.9 | 0.001 |
| Aldehyde C12 MNA | 0.40 | 5.0 | 1.428 |
| Radjanol | 1.40 | 5.0 | 0.001 |
| Iso-E Super | 4.30 | 5.3 | 0.001 |
| Thibetolide | 3.30 | 5.4 | 0.001 |

After mixing, the samples were allowed to equilibrate for 24 hours at room temperature. The samples were rated for fragrance intensity. 5 expert panelists were used. The results are shown below:

| | Number selecting | |
|---|---|---|
| | fragrance composition A | fragrance composition D |
| Dilute | 0 | 5 |
| Concentrated | 0 | 5 |

### EXAMPLE 9

The following bases were prepared:

| | Softener base C | |
|---|---|---|
| Ingredient | (comparative) | Softener base D |
| Arquad 2HT (75% ai) | 3.80 | 2.2 |
| Semtol 70/28 | — | 3.3 |
| Pristerine 4981 | 0.63 | 0.37 |
| Cetyl hydroxyethyl | 0.03 | 0.03 |
| cellulose | | |
| Perfume* | 0.25 | 0.25 |
| Dye | 0.1 | 0.1 |
| Formalin(36%) | 0.08 | 0.08 |
| Water | To 100 | To 100 |

*The following fragrance composition were used:
Softener Base C: Fragrance composition A (see example 1)
Softener Base D: Either fragrance composition A (see example 1) or fragrance composition D (see example 8).

After mixing, the products were allowed to equilibrate for 24 hours at room temperature. A comparison between the softener base C, containing the fragrance composition A (sample 8A) and the oil-based fragrance delivery vehicle, i.e. softener base D, containing the fragrance composition A (sample 8B) was made. In addition, a comparison of the softener base C containing the fragrance composition A (sample 8A) and the oil-based product containing the fragrance composition D (sample 8C) was made. The products were rated for fragrance intensity. 5 expert panelists were used.

| Product Comparison | Number selecting |
|---|---|
| 8A [symbol] 8B | 5 [symbol] 0 |
| 8A [symbol] 8C | 2 [symbol] 3 |

In the examples:

| | |
|---|---|
| HEQ | is an ester quaternium compound, dialkylyloxy |
| | dimethyl ammonium chloride, |
| | where the alky is hardened tallow; |
| SPE | is a Sucrose Poly Ester Ryoto ER290; |
| DPG | is dipropylene glycole; |

The intensity of an aroma chemical, e.g. “low odor intensity”, “moderate odor intensity” and “high odor intensity” as set forth in the Examples 5, 6 and 7 is a well known measure of how well an aroma chemical is perceived and may be evaluated, for example by the Labeled Magnitude Scale as described by B. G. Green at al. in Chem. Senses 21: 323-334, 1996.

1. A fragrance delivery vehicle comprising a water-insoluble oil, a conditioner containing a cationic active at a level above 0.5% (wt), and at least 0.1% (wt) of a fragrance composition comprising a first aroma chemical with a clogP of 3.0 or less and a second aroma chemical having a clogP of at least 4.0.

2. A fragrance delivery vehicle according to claim 1, wherein the first aroma chemical has a clogP of 2.5 or less.

3. A fragrance delivery vehicle according to claim 1, wherein the fragrance composition comprises at least 0.5% (wt) of the first aroma chemical based on the total weight of the fragrance composition.

4. A fragrance delivery vehicle according to claim 1, wherein the first aroma chemical has a vapor pressure at 25° C. of greater than 0.07 mm Hg.

5. A fragrance delivery vehicle according to claim 1, wherein the fragrance composition comprises at least 20% (wt) of the second aroma chemical based on the total weight of the fragrance composition.

6. A fragrance delivery vehicle according to claim 1, wherein the second aroma chemical has a vapor pressure at 25° C. of less than 0.02 mm Hg.

7. A fragrance delivery vehicle according to claim 1, wherein the first aroma chemical has a sensory threshold concentration below 100 ng per liter.

8. A fragrance delivery vehicle according to claim 1, wherein the cationic active is selected from the group consisting of a dialky cationic active, a monoalky cationic active, and mixtures thereof.

9. A fragrance delivery vehicle according to claim 1, wherein the water-insoluble oil is selected from the group consisting of mineral oils, ester oils, sugar ester oils, natural oils, and mixtures thereof.

10. A fragrance delivery vehicle according to claim 9, wherein the sugar ester oil is a sucrose polyester.

11. A fragrance delivery vehicle according to claim 9, wherein the sugar ester oil is selected from the group consisting of an oily sugar derived from a cyclic polyol (derivative-CP), an oily sugar derived from a reduced saccharide (derivative-RS), and mixtures thereof.

12. A fragrance delivery vehicle according to claim 1, wherein the first aroma chemical is present in the fragrance composition at a level that is at least 1% (wt) based on the total weight of the fragrance composition.

13. A process for conditioning and fragrancing a substrate and fragrancing a product comprising:
(a) combining a fragrance delivery vehicle with a product for conditioning and fragrancing a substrate, the fragrance delivery vehicle comprising a water-insoluble oil, a conditioner containing a cationic active at a level above 0.5% (wt), and at least 0.1% (wt) of a fragrance composition comprising a first aroma chemical with a clogP of 3.0 or less and a second aroma chemical having a clogP of at least 4.0; and
(b) contacting the product containing the fragrance delivery vehicle with a substrate in an aqueous medium; and
(c) optionally drying the substrate.

14. A process according to claim 13, wherein the substrate is a fabric or hair.

15. A process according to claim 13, wherein the product is selected from the group consisting of laundry detergents, fabric conditioners, hair conditioners, shampoos, hair creams, fabric softeners, fabric dewrinklers, and cleansers.

16. A process for enhancing the fragrance of a consumer product comprising incorporating a fragrance improving quantity of a fragrance delivery vehicle according to claim 1 into a consumer product.

17. A process according to claim 16, wherein the consumer product is selected from the group consisting of laundry detergents, fabric conditioners, hair conditioners, shampoos, hair creams, fabric softeners, fabric dewrinklers, and cleansers.

18. A process for designing a fragrance delivery vehicle, which process comprises:
(a) selecting a first aroma chemical having a clogP of 3 or less;
(b) combining the first aroma chemical with a second aroma chemical having a clogP of at least 4.0 to form a fragrance composition;
(c) optionally combining the fragrance composition with additional fragrance components or fillers; and
(d) incorporating at least about 0.1% (wt) of the fragrance composition with a water-insoluble oil and a conditioner containing a cationic active at a level above about 0.5% (wt) to form the fragrance delivery vehicle.

19. A process according to claim 18, wherein the first aroma chemical is selected from the group consisting of aroma chemicals having a vapor pressure at 25° C. of greater than 0.07 mm Hg.

20. A process according to claim 18, wherein the first aroma chemical is selected from the group of aroma chemicals having a sensory threshold concentration of less than 100 ng per liter.

21. A process according to claim 19, wherein the first aroma chemical is selected from the group of aroma chemicals having a sensory threshold concentration of less than 100 ng per liter.
